(19) United States
(12) Patent Application Publication
(10) Pub. No.: US 2014/0129784 A1
(43) Pub. Date: May 8, 2014

(54) METHODS AND SYSTEMS FOR POLLING MEMORY OUTSIDE A PROCESSOR THREAD

(71) Applicant: MELLANOX TECHNOLOGIES, LTD., Yokneam (IL)

(72) Inventors: Hillel Chapman, Ein HaEmek (IL); Dror Goldenberg, Zichron Yaakov (IL)

(73) Assignee: Mellanox Technologies, Ltd., Yokneam (IL)

(21) Appl. No.: 13/671,475

(22) Filed: Nov. 7, 2012

(51) Int. Cl. G06F 12/00

(52) U.S. Cl. 711/154; 711/E12.001

(57) ABSTRACT

A system and method of monitoring a memory address is disclosed which may replace a polling operation on a memory by determining a memory address to monitor, notifying a cache controller of the memory address, and cause execution on a polling thread to wait. The cache controller may then monitor the memory address and notify the processor to resume execution of the thread. While the processor is waiting to be notified, it may enter a power save state or allow more time to be allocated to other threads being executed.

### TECHNICAL FIELD

This disclosure relates to the field of processor optimization.

### BACKGROUND

In a computer system running a program, polling generally consists of a programming loop executed by a processor to read a memory address, check the memory address's value to determine availability, and if the check fails, go back to the read cycle to repeat. Although polling generally provides availability of the polled data quickly, one concern with polling is that it may waste processor cycles waiting for the polled memory condition to occur that determines availability. The processor may cycle on this poll loop until the check passes, blocking continued execution of a process and cycling the same execution loop repeatedly.

It is accordingly an object of the disclosure to provide the benefits of polling data without the drawbacks presented by wasted processor execution cycles.

### SUMMARY

Embodiments disclosed herein provide systems and methods for polling on data. In one embodiment, a processor executing a thread may mark an address location for monitoring, and until this address is accessed by a Network Interface Controller (NIC), direct memory access (DMA) processing agent, another assistant processing agent, graphic processing unit (GPU), another processor, another thread on the same processor, or the like, the processor will wait to continue executing the thread. While waiting on the data at the address to change, the processor execution may be modified by entering a lower power state with a fast system recovery to full power when the data arrives, providing more resources to other threads running on the processor, or notifying the operating system to enable the scheduling of other processes to run instead.

Additional aspects related to the embodiments will be set forth in part in the description which follows, and in part will be obvious from the description, or may be learned by practice of the embodiments.

It is to be understood that both the foregoing general description and the following detailed description are examples and explanatory only and are not restrictive of the application, as claimed.

### BRIEF DESCRIPTION OF THE DRAWINGS

FIG. 1 illustrates an example system consistent with embodiments presented herein and having one or more CPUs, corresponding cache memory units, a cache coherency controller, system memory, DMA controller, and NIC.

FIG. 2 illustrates an example process consistent with embodiments presented herein that marks an address for monitoring and detects when the memory value changes.

FIG. 3 illustrates a high-level example process consistent with embodiments presented herein that implements system level detection of a polling process.

FIG. 4 illustrates a more detailed example process of using system components to detect and handle CPU polling.

### DETAILED DESCRIPTION

Reference will now be made in detail to the example embodiments that are illustrated in the accompanying drawings. Wherever possible, the same reference numbers will be used throughout the drawings to refer to the same or like parts.

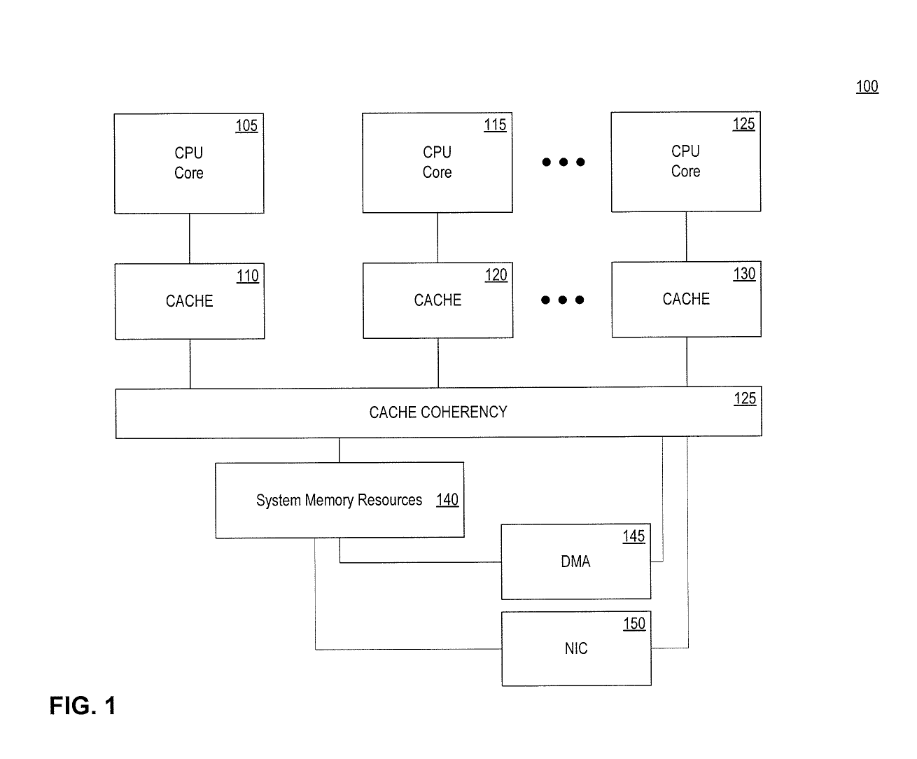

The embodiments described herein present a way of effectively moving a memory polling process out of a processor by leveraging supporting system components available in the system. FIG. 1 illustrates an example system diagram 100 with one or more central processing units (CPUs) (not pictured), containing one or more CPU cores, corresponding cache memory units, a cache coherency controller, system memory, direct memory address (DMA) controller, and NIC. Each CPU may contain one or more CPU cores, represented as 105, 115, and 125. The CPUs or CPU cores may generally be referred to as a processor. Each of the CPU cores typically has at least one corresponding memory cache associated with the core, represented as 110, 120, and 130, respectively. In some embodiments systems with two or more CPU cores may share another cache (not pictured), and systems with two or more CPUs may share another cache for all CPUs (not pictured). A cache coherency controller 135 manages cache values across all of the caches typically so that each one contains the same values. The system memory resources 140 may include other types of system memory, including random access memory, non-volatile memory, and all other memory address spaces, registers, and buffers available for reading or writing by the system. Other functions may also access the memory: for example a DMA controller 145 provides “data movement” utility as instructed by the program (CPU core). Another example is a NIC that can move inbound packet directly into memory, and notify program (CPU) through a completion queue also through the memory. These other functions have a direct interface to the system memory resources and may store data in the system memory resources directly without CPU intervention. In the above example, a DMA controller may actually represent any other input output device, such as mass storage, networking, sensors, etc.

One skilled in the art will recognize that the system as illustrated by FIG. 1 and described herein is not meant to be exhaustive or limiting, but merely a basic illustration of a system for the purposes of discussion herein. An alternative configuration may involve multiple systems in a distributed computing environment scaled to contain functionally similar components as those referenced herein, including an additional addressable memory space and a memory manager.

On one or more of the CPU cores, 105, 115, or 125, a process may execute in one or more threads where each thread represents a set of instructions or operations related to the process to be performed by the CPU. A program is a set of instructions or operations organized into one or more processes that may be executed in one or more threads. Typically an executing program must wait on an external condition to be met before execution of the program can begin or continue. For example, a program may wait for an input via a network interface before it can continue execution. In this way, a network interface may be considered a type of processing agent operating within a computer system. Other processing agents may be other independent and inter-dependent processes running within the computer system, such as a process thread running on a CPU core, a data bus controller, a memory controller, processes running in a graphical processing unit (GPU), a motherboard controller, operations executed via a peripheral component interconnect (PCI) bus, input output devices, and the like. Such processing agents may need to communicate through an inter-process communication (IPC) with each other to assist the flow of operations in the system, present state information, or convey that an event has occurred, among other reasons. Forms of IPCs include the use of communication queues, semaphores, or specified memory locations to facilitate communication with each other. Some examples of IPC tasks may include CPU to CPU communications, e.g., process initiation, process done, etc.; DMA to CPU, e.g., memory store completion; input/output (IO) to CPU, e.g., completion and packet arrival; and kernel idle loops, e.g., polling for new tasks.

There are at least two means of receiving an inter-process communication: 1) polling and 2) interrupts. Interrupts enable a processor to continue execution of other processes by putting a thread for handling processing of a particular interrupt into a sleeping (non-executing) state until an interrupt signal is triggered which causes the system to wake up (resume execution of) the handler thread and handle the interrupt. For example, in a NIC, the NIC may receive data into a memory buffer until the buffer is full, then trigger an interrupt to inform the processor that the NIC needs attention. This, in turn will cause the processor to process the NIC's memory buffer and clear the interrupt signal. Using interrupts, however, may not meet a desired performance criteria due to latency and system overhead introduced by the interrupt mechanism.

In computing systems, polling may provide lower latency and quicker availability than using interrupts. Polling generally consists of a process loop comprising reading a memory address, checking the value to determine availability, and if the check fails going back to the read cycle to repeat. Whereas interrupt handling may introduce a delay between availability and access by a program thread, in an environment where a processor is running a polling thread, the data generally becomes accessible to the thread once available and the program may continue its execution without delay. Where quick availability and fast input/output connection speeds are required, the minimal latency of polling programming may make overall execution quicker than interrupt programming, resulting in high message rates. For example, when a polling thread is executing, all the thread can do is poll. The polling thread must wait until the polled address becomes valid or until the thread times out before the thread is released to continue the program.

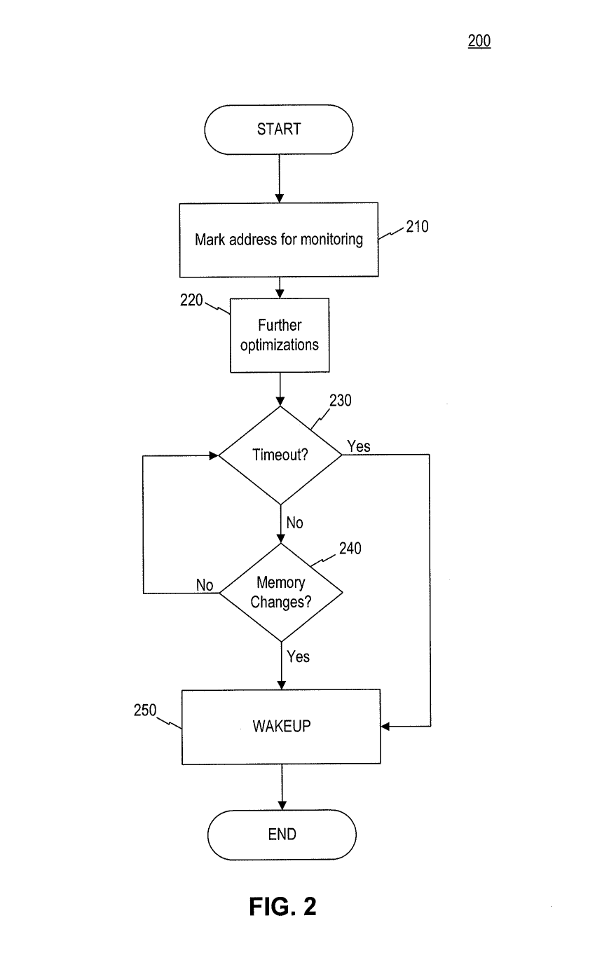

FIG. 2 illustrates an example process 200 consistent with embodiments presented herein that identifies an address set (a list of addresses or address ranges) for monitoring and detects when the memory value changes in one of the address ranges without the need to continue polling in the processor. Process 200 begins with a memory address set being marked for monitoring (step 210). The memory address set may include one or more address ranges for monitoring, with each of the address ranges including one or more system addressable memory spaces. While the thread is waiting on the memory address or range to change, in some embodiments, the system may be further optimized (step 220) by, for example, entering a lower power state or suspending operation of the thread until data arrives, implementing a fast recovery when data arrives, providing more resources to other threads running on the CPU core, or notifying the operating system, thereby enabling the operating system to schedule other processes to run. The system may optionally set a time out value to resume thread execution should the memory address set remain unmodified for the duration of the time out period (step 230). The system may then determine if a value in one of the address ranges in the memory set changes (step 240). If the system determines that the value in one of the address ranges in the memory address set changes, the system may notify the CPU to resume operations (step 250). In some embodiments where the CPU is made to sleep, side signals may be used from the CPU to an input output device (such as a NIC or DMA engine) to signal that data has arrived. The side signals may be used to begin waking up the CPU on data arrival to reduce process resume latency. If the system does not determine that the value of the memory address or range has changed, then the process 200 may loop back to step 230, causing the thread to wait until a timeout, interrupt, or data arrival occurs.

In some embodiments, the step 210 of marking an address set for monitoring may be accomplished by implementing a new programming instruction to be interpreted by the processor's instruction assembler. The processor's instruction assembler translates a set of system level programming instructions into system code suitable for execution by the processor. An assembly language command is a command supported by a particular processor. In some embodiments a new assembler instruction may take as arguments: an address, optional size, data condition, and optional timeout, e.g., POLL {address} {size} {condition} {timeout}. When the instruction is processed the memory space or range starting at {address} with the length {size} is read and compared to the {condition}. If no {size} is specified, a default value may be used based on the address specified (type of memory read) and CPU architecture. If the condition is not met, then the instruction will wait until {timeout} 230, interrupt, or data change notification 240. Once one of these events occurs, the program may either resume or reenter a waiting state depending on the event and whether the {condition} has been met. In some embodiments, the system may be configured to ignore interrupts while in the waiting state. In some embodiments, the command may return the value(s) located at the address set to allow the program to determine whether the command completed due to the memory becoming available at the address set location(s) or whether the operation timed out. The {address} may be any addressable space, including a semaphore, queue, memory register, buffer, virtual memory space, or system memory space. The {address} may be “marked” for monitoring by executing an exclusive read on the address range. Doing so signals the cache coherency controller to monitor the address range and signal the thread if the value in the address range changes. Depending on the granularity available to the cache coherency controller, the cache coherency controller may mark a broader range of addresses to monitor than those specified which may include adjacent memory addresses. It can also mark multiple addresses, for example by including multiple POLL instructions. In addition to or in place of the cache coherency controller, one of ordinary skill in the art will recognize that another memory manager may be used to achieve the same result, even across multiple machines in a distributed computing environment, when shared memory space is marked for monitoring.

In some embodiments, step 220 may be executed to include additional optimization. In a case where a thread must wait on an address range to meet a condition, because an address range is under monitoring by the system (including the cache coherency controller), the thread need not continue to operate. For example, in some embodiments, the system may enter a low power (or “sleep”) mode until timeout 230, data arrival 240, or system interrupt (which would cause interrupt handling to occur by the system in a traditional way). The level of reduced power state may support a fast recovery from the reduced power state (or “wake up”). Some levels of reduced power state may clear volatile system memory, requiring loading memory contents from non-volatile memory on system recovery. Alternatively, instead of entering a sleep mode, in some embodiments, the processor time allocated to the waiting thread may be reallocated to the other threads running on that CPU core. An operating system (OS) process scheduler allocates execution time on available CPUs for each of the running threads, and in some embodiments, the process 200 may be further optimized at step 220 by notifying the OS process scheduler to allow the OS to prioritize between threads. In embodiments where the waiting thread is waiting on high priority data, additional sequential logic circuits (or “finite state machines (FSMs)”) may be added to the CPU or CPU core to notify the OS that the high priority data has arrived to request higher execution priority on wake-up. In some embodiments, the CPU or CPU core and NIC or host channel adapter (HCA) may be integrated into one package, which would accommodate a control path for waking up the CPU core directly from within the HCA/NIC data path.

One of ordinary skill in the art will recognize that step 210 and process 200 may be modified to support additional features. For example, in some embodiments another version of a processor instruction similar to the example POLL instruction described above may take similar arguments and mark memory locations for monitoring, but allow additional commands to follow before waiting after executing a final POLL instruction. This may allow a programmer to set up polling on multiple address ranges, e.g., set a single thread polling multiple queues and semaphores because the cache coherency controller may monitor multiple address ranges.

In some embodiments, a processor instruction similar to the example POLL instruction may support more complex representations for the {condition} element. The {condition} element may represent a percentage or limited number of bits in the {address} range under monitoring. For example, the {condition} may represent the target value for every tenth data element (e.g., bit, byte, word, double word, etc.) in the {address} range. In some embodiments, functions may be performed on the monitored {address} range and compared to a {condition}. For example, a hash function executes an operation on an input value and produces a representation of the input value that is typically shorter in length than the input value. Using a hash function, the same input will always produce the same output, but other inputs may also produce the same output. In some embodiments, a hash function may be used on the {address} range and compared to {condition}. A bloom filter executes a number of hash functions on an input element to retrieve the same number of bit positions in a bloom filter array. If each position in the array contains a “1” then the input element may be in a data set, but if any of the positions in the array contains a “0” then the input element is definitely not in the data set. In some embodiments, the {condition} may be a bloom filter array to be used in combination with bloom filter hash functions on the {address} range to determine whether the {address} may match one or more desired values (the one or more desired values would be used to create the bloom filter array).

In some embodiments, a processor instruction similar to the example POLL instruction may support additional features. For example, the {address} range may translate into one or more pages (or fixed-length contiguous memory blocks) in memory, which may make the monitoring of the memory range more efficient. In another example, a bit may be added in all second level cache entries, to cause all CPU cores to be notified when the entry is evicted or modified. In some embodiments, optional caching hints may be added so that the data in the address or range will be brought immediately to the particular CPU core's first level cache. This becomes a powerful tool for providing a multi-way address monitor across CPUs and CPU cores.

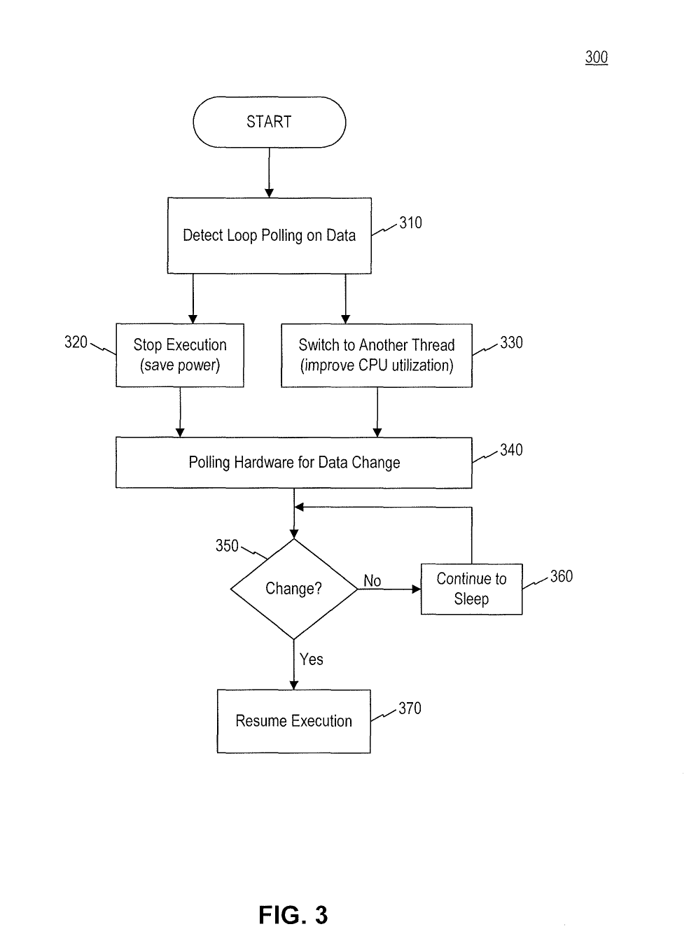

Alternatively, the example process 200 as described in the embodiments above may, instead of executing an assembly language command to be interpreted by the CPU, use external logic added to the system including addressable memory registers to achieve the same result. For example, rather than an assembly language command as illustrated above as, POLL {address} {size} {condition} {timeout}, the same result may be achieved in external logic through separate standard assembly language commands addressed to a set of addressable registers used by the external logic, e.g., WRITE reg1 {address}, WRITE reg2 {size}, WRITE reg3 {condition}, WRITE reg4 {timeout}, where each of reg1, reg2, reg3, and reg4, indicate a memory space available for reading by the external logic to process the POLL equivalent command. The external logic may then notify the cache controller to monitor {address} (with {size}). Once the external logic processes the monitoring, it may notify the CPU to allow for optimizations as in step 220. In some embodiments, step 210, marking an address or range for monitoring may be accomplished by implementing a loop detection algorithm in the CPU or CPU core that triggers a FSM (or other logic circuit) for detecting when a polling condition is executing. FIG. 3 illustrates an example process 300 consistent with embodiments presented herein that implements system level detection of a polling process, and moves the polling from the CPU core to the system.

In some embodiments, a loop polling on data in a particular address or range of addresses is detected and moved to system monitoring (step 310). In some embodiments, the thread is put into a waiting state to reduce power consumption (step 320). In other embodiments, execution is switched to another thread to improve CPU utilization (step 330). The polling may continue using the system to detect a change in the data (step 340). In some embodiments, a determination is made as to whether a change is detected (step 350). If no change occurs, the thread may continue to sleep (step 360). If a change is detected, execution may be resumed (step 370). Once execution is resumed, the data may be processed by the thread. If the data is incorrect or incomplete, polling may continue which may again be moved into the system for monitoring and detection.

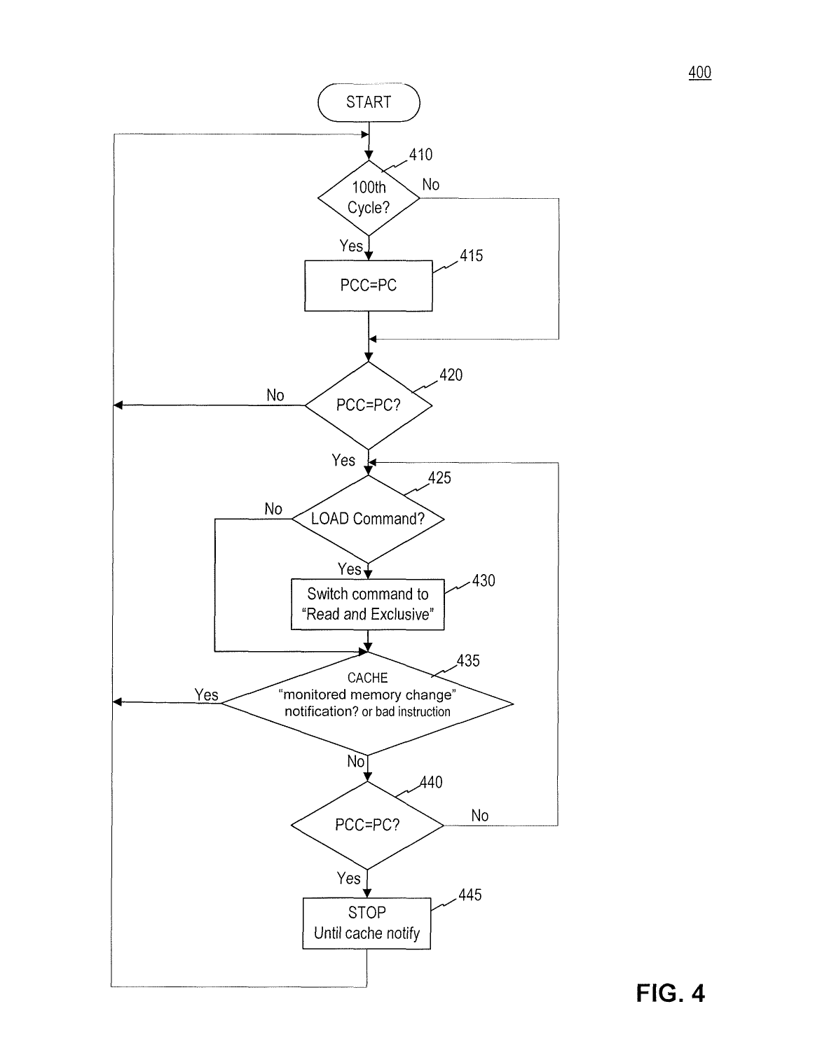

FIG. 4 illustrates a more detailed example process 400 of using the system to detect and handle CPU polling, moving the polling from the CPU to the system. In particular, process 400 includes additional detail on how a poll loop condition detection algorithm may be added to the CPU or CPU core. Not pictured, a new register, program counter copy (PCC) is defined. The process 400 may detect when a looped polling is occurring in a thread and switch the read command to a “read and exclusive” command, which then may signal the cache coherency controller to monitor the target address.

The process will determine whether it has been 100 cycles (step 410) since examining the last examined instruction. The value of 100 cycles may be changed to another number of cycles and is used here for illustrative purposes. By testing every 100 cycles the process 400 does not test every instruction, mitigating some of the design overheads in the loop detection logic and on the address find logic. In some embodiments, if the loop cycle is not the one-hundredth from the previous cycle tested, then the poll process detection will loop, waiting to test the next one-hundredth cycle. If the loop cycle is the one-hundredth from the previous cycle, the PCC may be set to the CPU's PC (or instruction pointer) (step 415). Thus, the PCC contains the instruction to be tested for looping. After the PCC has been set to the PC, at least one processor cycle will occur, which allows that the value of the PC may change. If the PCC equals the PC (step 420), then the process will continue, having detected that a looping condition may occur because the same instruction as the tested instruction has been detected later within the 100 cycles, indicating that the tested instruction has occurred at least twice within the 100 cycles. If PCC does not equal PC, then the process will go back to step 405 to evaluate the next processor command or instruction. The execution of step 420 may continue to test PCC against the PC for up to 100 cycles, at which point it will be reset to test a new possible looping condition. Because the PC changes as new instructions are executed, if the PCC equals the PC command then the PC command may be a looping command because it has been evaluated before. The 100-cycle limit helps to ensure that two commands that may be identical but in two different areas of the program are less likely to be considered a loop. It also resets the logic so that a command that is not a looping command would not be evaluated indefinitely.

The next executed command (in the PC) may then be checked (step 425) to determine if it includes a LOAD command, thereby signifying that a potential polling loop has been detected. A counter may be added (not shown) to add a timeout possibility, i.e., if the counter reaches a timeout count, then the process 400 may return to step 405 and resume thread operation, which may have a program handler to handle a timeout event. If a LOAD command was not detected, then the process will jump to step 435. If a LOAD command was detected, then the command may be switched to a “read and exclusive” command (step 430) and executed, which notifies the cache coherency controller to monitor the address corresponding to the LOAD command. From this point on, the cache coherency controller may notify the CPU on any change to the address. Because it was evaluated in step 420 that PCC equals PC, this signified that the same command had been executed twice within 100 cycles, indicating that a loop may occur. Checking for at least two executions prior to changing the LOAD command into a “read and exclusive” helps reduce the load on the cache coherency controller. In step 435, if a cache memory change notification for the monitored memory follows step 430, the process should restart because there is no optimization since the memory changed.

Also in step 435, if a “bad instruction” is executed by the CPU the process should restart (fail), since the optimization cannot be performed for a loop containing a bad instruction. A “bad instruction” is an instruction that causes a change in the CPU state or in the memory that occurs according to the number of times the loop was executed. An example for a “bad instruction” is an increment of an internal CPU register (counts the number of times the loop was ran).

If not, then the PCC is compared to the PC (step 440). If they are not equal, then the next PC will be tested in step 425 until all of the commands that are executing in the loop are tested for possible monitoring or for a “bad instruction.” Even if the poll loop contains several LOAD commands polling several memory addresses, each one of these will be evaluated by the loop from step 425 to step 440. If PCC equals PC in step 440, then all of the instructions in the loop have been evaluated. The system may STOP execution of the polling thread in step 445. The STOP may also put the thread in a sleeping state, reduce power to the processor, reallocate processor resources to other threads, or other optimizations. When a cache memory change notification occurs, the system will wake up the polling thread to resume operation. The data may then be processed by the polling thread. If the thread determines that it needs to resume polling, the process 400, will have looped back to step 405 to continue looking for a polling loop. In some embodiments where the processor is made to sleep, side signals may be used from the processor to the input output device (such as a NIC or DMA engine) to signal that data has arrived. The side signals may be used to begin waking up the processor on data arrival (before the memory actually changes) and reduce process resume latency (reduce the overhead due to wake up from low power mode).

Consistent with process 400, an example implementation of a mechanism provided for in the processor to detect that a poll loop has occurred is provided below:
1. A new register is defined, PCC (program counter copy).
2. Wait for the 100'th cycle.
3. Set PCC=PC.
4. If the assembler command cannot be part of a poll loop, restart to stage 2.
5. If PC!=PCC goto stage 4.
6. If load assembler command is executed it will be switched to “read and exclusive” (cache must notify the CPU on any change to this address from this point forward).
7. If cache notifies a change, then restart to stage 2.
8. If PC!=PCC then goto stage 6.
9. Perform the optimization (low power mode/task switch/etc.), wait till cache change.

One skilled in the art will recognize that the process 400 could be altered to achieve the same or similar effect. For example, for parallelism, the “load and exclusive” command can be split to load, occurring in real time, and get_exclusive which may occur without stopping the CPU, in which case, a full loop must occur after the get_exclusive command is committed.

Other embodiments will be apparent to those skilled in the art from consideration of the specification and practice of the embodiments disclosed herein. It is intended that the specification and embodiments be considered as examples only, with a true scope and spirit being indicated by the following claims.

What is claimed is:

1. A system of monitoring a memory address comprising:
at least one processor executing at least one thread;
one or more memory units; and
a memory controller;
wherein the at least one processor is configured to:
determine a memory address for monitoring,
notify the memory controller of the memory address, and
cause the thread to wait; and
wherein the memory controller is configured to:
monitor the memory address, and
notify the processor if the memory address is accessed.

2. The system of claim 1, wherein the processor is configured to receive a signal from the memory controller that the memory address is accessed and resume execution of the thread.

3. The system of claim 2, wherein the processor is configured to save power while the thread is waiting.

4. The system of claim 2, wherein the processor is configured to execute other threads while the thread is waiting.

5. The system of claim 1, wherein the memory address includes a range of one or more addresses.

6. The system of claim 1, wherein determining the memory address comprises receiving an instruction including the instruction and a memory address for monitoring.

7. The system of claim 6, wherein the notifying the memory controller comprises executing a read and exclusive instruction on the memory address.

8. The system of claim 1, wherein the determining the memory address comprises
detecting a polling sequence on a memory address, and
wherein the notifying the memory controller comprises changing a read instruction to a read and exclusive instruction.

9. The system of claim 6, wherein the instruction further includes a timeout value, wherein the timeout value indicates a maximum time allowed before resuming execution of the thread.

10. The system of claim 6, wherein the instruction further includes a data condition value, wherein the value in the memory address is compared with the data condition and, if the value in the memory address does not meet the data condition, the thread is caused to wait and the memory address further monitored.

11. The system of claim 1, wherein the processor is configured to receive a signal from an input device indicating that the memory address is accessed and resume execution of the thread.

12. The system of claim 1, further comprising:
an input device, wherein the input device and processor are integrated.

13. A method of monitoring a memory address comprising:
determining in a CPU core executing a thread, a memory address for monitoring;
notifying a memory controller of the memory address;
causing the thread to wait;
monitoring the memory address in the memory controller;
notifying the CPU core if the memory address is accessed; and
resuming execution of the thread.

14. The method of claim 13, wherein the CPU core is configured to save power while the thread is waiting.

15. The method of claim 13, wherein the CPU core is configured to execute other threads while the thread is waiting.

16. The method of claim 13, wherein the memory address includes a range of one or more addresses.

17. The method of claim 13, wherein the determining the memory address comprises receiving an instruction including the instruction and a memory address for monitoring.

18. The method of claim 17, wherein the notifying the memory controller comprises executing a read and exclusive instruction on the memory address.

19. The method of claim 13, wherein the determining the memory address comprises
detecting a polling sequence on a memory address, and
wherein the notifying the memory controller comprises changing a read instruction to a read and exclusive instruction.

20. The method of claim 13, wherein the memory address is updated by at least one of: a direct memory address controller, a host networking adapter, or a network interface card.

21. The method of claim 17, wherein the instruction further includes a timeout value, wherein the timeout value indicates a maximum time allowed before resuming execution of the thread.

22. The method of claim 17, wherein the instruction further includes a data condition value, and the method comprises:
comparing the value in the memory address with the data condition;
where the value in the memory address does not meet the data condition, causing the thread to wait; and
continue monitoring the memory address in the memory controller.

22. The method of claim 13, wherein the CPU core is configured to receive a signal from an input device indicating that the memory address is accessed prior to resuming execution of the thread.

23. The method of claim 13, wherein the CPU core and an input device are integrated.
